(19) United States
(12) Patent Application Publication
(10) Pub. No.: US 2010/0098377 A1
(43) Pub. Date: Apr. 22, 2010

(54) LIGHT CONFINEMENT USING DIFFUSERS

(76) Inventor: Noam Meir, Hezlia (IL)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/472,993

(22) Filed: May 27, 2009

Related U.S. Application Data
(60) Provisional application No. 61/106,000, filed on Oct. 16, 2008.

(51) Int. Cl. G02B 6/26; F21V 7/00

(52) U.S. Cl. 385/28; 362/296.01

(57) ABSTRACT

An illumination structure includes a waveguide, a discrete light source embedded within the waveguide, and a mode-conversion reflector. The mode-conversion reflector converts at least some unconfined modes from the light source into confined modes that propagate fully within the waveguide.

### CROSS-REFERENCE TO RELATED APPLICATIONS

This application claims priority to and the benefit of U.S. Provisional Patent Application Ser. No. 61/106,000, filed on Oct. 16, 2008, and U.S. patent application Ser. No. 12/155,090, filed on May 29, 2008, which are hereby incorporated herein by reference in its entirety.

### TECHNICAL FIELD

Embodiments of the invention generally relate to coupling light sources to waveguides, and, in particular, to efficiently capturing light emitted from a light source in a waveguide.

### BACKGROUND

Light propagates within a waveguide (also known as a “light guide” for applications involving visible light) provided it is trapped inside the waveguide and cannot exit therefrom. Two well-known types of models may be employed to determine the amount of light trapped inside a waveguide: a light-ray model and a light-wave model. In the light-ray model, rays of light strike the surfaces of the waveguide—particularly the top and bottom surfaces—with angles of incidence measured with respect to the surfaces of the waveguide. If the angle of incidence is larger than the critical angle of the waveguide, the incident light ray will be totally reflected and therefore trapped within the waveguide. FIG. 1 illustrates light rays 102 trapped within a waveguide 100 having an index of refraction n₂. The light rays 102 strike a top surface 104 and a bottom surface 106 of the waveguide 100 with an angle of incidence θ, where θ is greater than the critical angle defined by the waveguide 100 and the surrounding material 101. Accordingly, the light rays 102 propagate within the waveguide 100 at an angle α.

As shown in further detail in FIG. 2, the angle of incidence θ of a propagating ray 202 with respect to the surface 104 of the waveguide 100 is defined against a perpendicular 206 from that surface. The critical angle is determined by the ratio of the refraction indices n₁, n₂ of the materials on both sides of the interface, i.e., the waveguide material 100 and the material 101 outside it. This material 101 may be air or any other medium in which the waveguide 100 is located, or the refraction index of the coating on the surface 104 of the waveguide.

In the light-wave model, the electromagnetic field equations (i.e., Maxwell's equations) are solved for the structure of the waveguide. Some solutions characterize an electromagnetic field that may extend in different directions in space, whereas “mode” solutions confine the field to a given geometry, e.g., that of the waveguide. Modes confined within the waveguide are called trapped modes. The solutions depend upon the dielectric values of the waveguide material and the material surrounding the waveguide. By analogy to the light-ray model, these dielectric values determine the refraction index of the light in the material.

In general, the conventional approach to coupling light into a waveguide is to inject the waveguide with an angular range of light that does not exceed the propagation angle. FIG. 3 illustrates of this approach using a side-emitting light-emitting diode (“LED”) 302 coupled to a waveguide 304. A concave surface 306 may be used to refract some of the light rays 308 emitted from the LED 302, but other light rays 310 may not be trapped within the waveguide 304. Another approach, as illustrated in FIG. 4, is to use reflection (provided by, e.g., a cap lens 402) to confine light emitted from an LED 404 that would otherwise exceed the critical angle of a waveguide 406. The fraction of light propagating within the critical angle is already confined by total internal reflection.

These conventional approaches, however, suffer from several disadvantages. The waveguides 304, 406 may not trap an acceptable percentage of the light emitted by the LEDs 302, 404, thus requiring a greater number of LEDs to achieve a given density of trapped light. The use of side-emitting light sources 302 may also set an upper bound on the size of the waveguide, because, as the waveguide increases in size, its surface area increases faster than the number of perimeter sites available to receive side-emitting sources 302. Moreover, an edge-illuminated waveguide requires side-emitting, pre-packaged light sources, thereby limiting the number and types of light sources that may be utilized. Finally, the use of either side-emitting light sources or cap lenses may increase the total cost and/or impede miniaturization of the planar illumination system. Clearly, a need exists for an efficient light-confinement structure capable of utilizing common top-emitting light sources.

### SUMMARY

Embodiments of the invention utilize a mode-conversion reflector or mirror, such as a diffuser reflector, to trap a portion of the light emitted into or within the waveguide. The conversion reflector structure converts most of the unconfined modes from the light source into confined modes that propagate fully within the waveguide.

In some embodiments, a top-emitting light source is embedded inside the waveguide. The embedded light source emits light directly into the waveguide, and the portion of the emitted light that is within the propagation angle (or, alternatively, the portion that is a confined mode) propagates fully within the waveguide. In some implementations, the diffuser reflector, as well as the light source, is embedded within the waveguide.

The top-emitting light source may be, for example, a bare-die LED chip that emits light in all directions (or over a wide range of angles). In various embodiments, more than 80% of the light from the light source is confined in the waveguide. The LED die structure geometry and position and the reflector may influence only the light emitted from the light source that is not within the propagation angle of the waveguide.

One or more of the following features may be included. The mode-conversion reflector may be a diffuser and/or may be disposed on a surface of the waveguide opposite an emission region of the light source, which may be a top-emitting LED. A second mode-conversion reflector may, if desired, be disposed below the light source, and about 91% of light emitted by the light source may retained within the waveguide thereby. The emission region may have an area smaller than an area of the first mode-conversion reflector, and the area of the first mode-conversion reflector may be smaller than an area of the second mode-conversion reflector.

The waveguide may include in-coupling, concentration, propagation, and/or out-coupling regions. The waveguide may have an entrance aperture approximately equal in size to an emitting area in the light source. The entrance aperture may be surrounded by mode-conversion reflectors.

In some embodiments, the light source is not embedded in the waveguide. For example, an illumination structure in accordance with the invention may include a waveguide having an entrance aperture, a discrete light source having an emission area substantially conforming to the entrance aperture, and one or more mode-conversion reflectors surrounding the entrance aperture. A light source may be attached the waveguide by means of an adhesive having a refractive index substantially matching the refractive index of the waveguide. The emission area of the light source may be attached to the entrance aperture of the waveguide through an anti-reflective coating.

In another embodiment, also involving a discrete light source that is not embedded in the waveguide, an optical element focuses light from the light source onto an entrance aperture of the waveguide. One or more mode-conversion reflectors surround the entrance aperture. The optical element may be a refractive or diffractive lens, and/or may be integral with the light source. In various implementations, the light source emits light within a narrow light-distribution angle. A mode-conversion reflector may be disposed on a surface of the waveguide opposite an emission region of the light source to convert some unconfined modes from the light source into confined modes that propagate fully within the waveguide.

### BRIEF DESCRIPTION OF THE DRAWINGS

In the drawings, like reference characters generally refer to the same parts throughout the different views. The lines that illustrate light rays in FIGS. 7-11, 15, and 16 are generated by ray-tracing simulation software. These views are a projection (i.e., a 2D) representation of the 3D models produced by the simulation. FIGS. 7-11 and 15-17 also include an aim sphere, generated by the simulation software, for presenting the aiming direction of the emitted light. In the following description, various embodiments of the present invention are described with reference to the following drawings, in which:

FIG. 1 is an enlarged sectional, schematic elevation of a waveguide having light rays trapped therein;

FIG. 2 is a detail of the waveguide schematically depicted in FIG. 1;

FIG. 3 is an enlarged sectional, schematic elevation of a side-emitting LED and attached waveguide;

FIG. 4 is a partially schematic elevation showing an LED and cap lens;

FIG. 5 is a schematic illustration of a Lambertian light source in accordance with an embodiment of the invention;

FIG. 6 is a schematic illustration of a Lambertian light-emitting surface in accordance with an embodiment of the invention;

FIGS. 7 is a schematic illustration of an LED and a waveguide in accordance with an embodiment of the invention;

FIG. 8 is a schematic illustration of a waveguide and an angle-converting reflector in accordance with an embodiment of the invention;

FIG. 9 is a schematic illustration of an LED embedded in a waveguide in accordance with an embodiment of the invention;

FIG. 10 is a schematic illustration of an LED embedded in a waveguide having a top diffuser reflector in accordance with an embodiment of the invention;

FIG. 11 is a schematic illustration of an LED embedded in a waveguide having top and bottom diffuser reflectors in accordance with an embodiment of the invention;

FIG. 12 is a schematic illustration of a system that may be optimized by simulation in accordance with an embodiment of the invention;

FIGS. 13A and 13B show simulation models for various embodiments of the invention;

FIG. 14 graphically depicts simulation results;

FIG. 15 is a schematic illustration of an LED attached to a waveguide in accordance with an embodiment of the invention;

FIG. 16 is a schematic illustration of an LED attached to a waveguide by an optical configuration in accordance with an embodiment of the invention; and

FIG. 17 is an enlarged sectional, schematic elevation of an optical funnel in accordance with an embodiment of the invention.

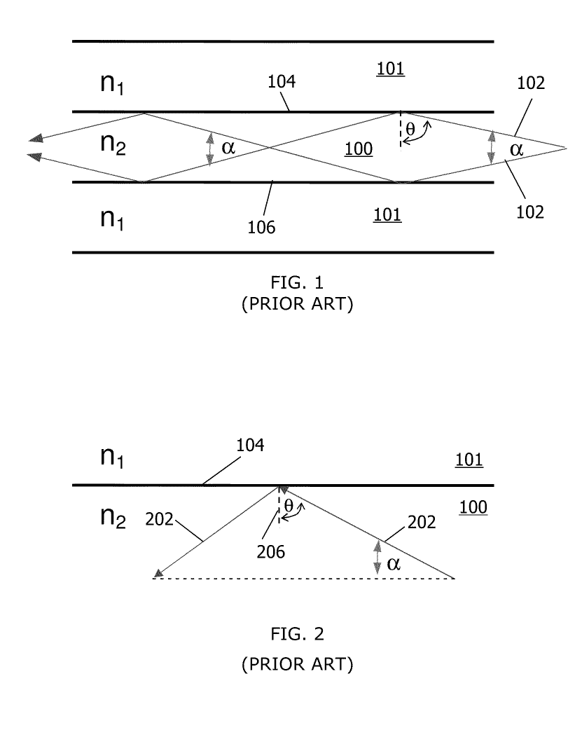

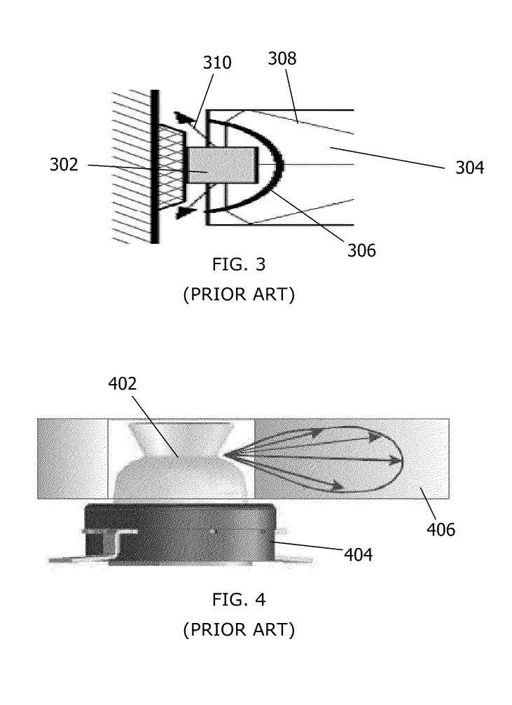

### DETAILED DESCRIPTION

Described herein are various approaches to combining a light source optically coupled to a waveguide with a mode-conversion reflector that confines light within the waveguide. The following description uses the ray model; the principle of operation, however, may also be understood using the wave model. In general, the critical angle θ_{c} of a waveguide is given by:

$$sin {θ}_{c} = \frac{{n}_{1}}{{n}_{2}} \qquad ( 1 )$$

where n₁ and n₂ are the indices of refraction for the waveguide and the surrounding material, respectively. The refractive index of a waveguide made from, for example, polymethyl methacrylate (“PMMA”) or BK7 glass, is approximately 1.5, and the refractive index of air is 1. The critical angle θ_{c} then, is approximately 41.8°, and the propagation angle a is 90°−41.8°=48.2°. Light propagating at an angle larger than the propagation angle will strike the waveguide surfaces at an angle smaller than the critical angle and, therefore, will not be trapped within the waveguide. To confine this untrapped light, its propagation angle may be changed to an angle sufficiently smaller than the propagation angle.

In accordance with embodiments of the invention, a mode-conversion reflector is used for this purpose. Changing the directional angle of a light ray is analogous to changing its light-propagation mode. In the ensuing description, references to a reflector that changes propagation direction may understood to connote a mode-conversion reflector. Such a reflector may be a diffusive reflector that, in contrast to a specular reflector (which reflects an incident light ray at an angle equal to the incident angle), reflects the incident light in a Lambertian distribution. Other types of reflectors, such as gratings or diffractive reflectors, may also be used.

The distribution of the reflected light from the diffusive reflector within the waveguide may depend on the geometry of the surface of the waveguide instead of the incident angle of light on the surface. A surface-emitting Lambertian light source may be characterized by the values of the cosines of the angles relative to the perpendicular of the surface, as shown by the following equation for Lambertian light distribution:

$$I ( θ ) = \frac{1}{π} cos ( θ ) \qquad ( 2 )$$

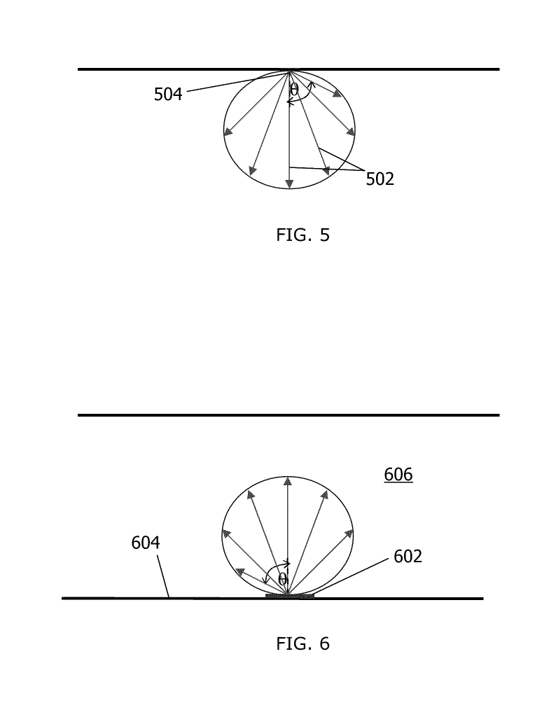

FIG. 5 illustrates an example of Lambertian light distribution for light rays 502 emitting from a Lambertian source 504. In some embodiments, a light source having a Lambertian, light-emitting surface is integrated into the surface of the waveguide—i.e., the light-emitting surface is part of the waveguide surface and emits light into the waveguide. A light-emitting surface 602 integrated into the surface 604 of a waveguide 606 is shown in FIG. 6.

Part of the emitted light may propagate within the propagation angle and thus be confined within the waveguide. The amount of light confined within the waveguide is the amount of emitted light that is within the propagation angle relative to the solid angle of the emission light. The following equation describes the solid angle calculation:

$${\int }_{0}^{2 π} {\int }_{0}^{\frac{π}{2}} I ( θ ) sin ( θ ) d θ d ϕ \qquad ( 3 )$$

Combining the Lambertian light distribution function of Equation 2 with the solid angle calculation of Equation 3 yields Equation 4, which describes the amount of light that is emitted into the full hemisphere by a Lambertian emitting light source.

$$\frac{1}{π} {\int }_{0}^{2 π} {\int }_{0}^{\frac{π}{2}} cos ( θ ) sin ( θ ) d θ d ϕ = 1 \qquad ( 4 )$$

In Equation 4, all of the emitted light is within the full hemisphere solid angle.

In the case of a Lambertian light-emitting surface integrated into a waveguide as described above, 55% of the emitted light is within the propagation angle α is, according to Equations 3 and 4. This result is obtained as follows:

$$\frac{1}{π} {\int }_{0}^{2 π} {\int }_{α}^{\frac{π}{2}} cos ( θ ) sin ( θ ) d θ d ϕ = 0.55 \qquad ( 5 )$$

In this case α is, as defined above, equal to 48.2°. Equations 3, 4, and 5 demonstrate that, when an LED with a Lambertian light-emitting surface embedded in the surface of the waveguide emits light into the waveguide, approximately 55% of the emitted light is within the propagation angle of the waveguide (assuming the waveguide refractive index of approximately 1.5 and the surrounding material is air).

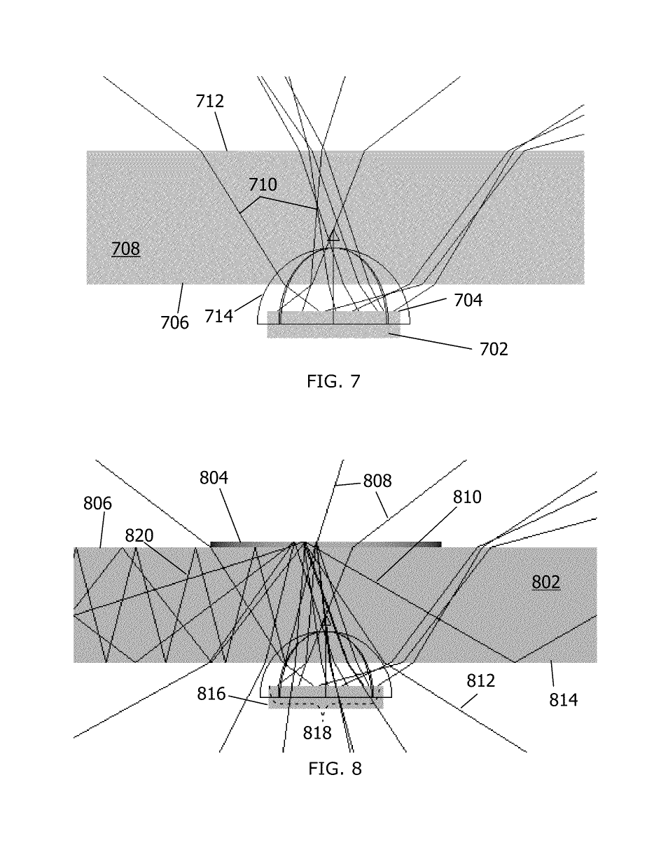

FIG. 7 illustrates a structure in which an LED source 702 includes an emitting surface 704 aimed at a bottom surface 706 of a waveguide 708, which may be a PMMA waveguide. Little, if any, light 710 emitted from the LED source 702 is confined within the waveguide 708. Instead, most of the emitted light 710 passes through a top surface 712 of the waveguide 708. An aim sphere 714 is generated by the ray-tracing simulation software to present the aiming direction of the emitted light 710.

If, however, an angle-converting reflector, such as a diffusive-scattering reflector or a diffuser reflector, is placed on the top surface of the waveguide above the light-entry area, part of the light that passes through the waveguide may strike the reflector and disperse in a Lambertian manner. Approximately 55% of the dispersed light may be within the propagation angle of the waveguide, in accordance with Equation 5. FIG. 8 illustrates a waveguide 802 with an angle-converting reflector 804 placed on a top surface 806. In general, the reflector 804 has a larger area than the emitting area 818 of the light source 816, and is centered thereover. Some light rays 820 are trapped in the waveguide 802, while other light rays 810 are reflected by the reflector 804 and become trapped in the waveguide 802. Still other light rays 812, however, reflect from the reflector 804 and escape through the bottom surface 814 of the waveguide 802. Some light rays 808 that are not trapped and do not strike the reflector 804 therefore escape the waveguide 802. It is possible to optimize the dimension of the reflector 804 to minimize the rays that are not trapped in the waveguide and do not strike the reflector.

In order to increase the amount of light confined within the waveguide 802, another diffusive reflector may be placed on the lower surface 814 of the waveguide 802. This lower diffusive reflector may be sized and/or placed to not obstruct, or to minimally obstruct, the entry of the light into the waveguide 802. In one embodiment, the lower diffusive reflector features an aperture to permit entry of the light rays from the light source 816; the aperture is sized to accommodate the light emitting area 818 of the light source 816. Such an aperture, however, may reduce the total reflection area of the lower diffusive reflector and thereby also reduce the reflector's ability to increase the amount of light propagating within the waveguide.

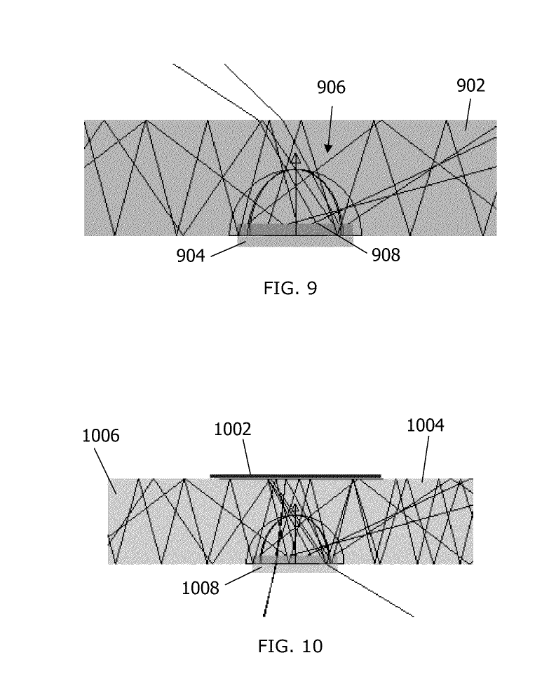

Embodiments of the invention overcome this potential limitation and increase the amount of light confined inside the waveguide by embedding an LED in the waveguide itself. FIG. 9 illustrates a waveguide 902 and an LED 904 embedded therein. The LED 904 emits light 906 from a top surface 908 thereof in a Lambertian distribution. This configuration may enable approximately 55% of the emitted light 906 to remain confined and propagate inside the waveguide 902, as described above. The thickness of the waveguide 902 may be equal or less than that of the LED die (or the longest dimension of the LED die or die array).

FIG. 10 illustrates a diffuser reflector 1002 disposed on a top surface 1004 of a waveguide 1006 featuring an embedded LED 1008. The diffuser reflector 1002, sized and positioned as discussed above in connection with the reflector 804, enables an additional amount of light, above and beyond the 55% already trapped, to propagate inside the waveguide 1006. This additional amount of propagating light is approximately equal to 55% of the light that strikes the diffuser reflector 1002. For example, if 45% of the light emitted from the embedded LED 1008 is untrapped (i.e., 55% is trapped, as explained above), and all of this untrapped light strikes the diffuser reflector 1002, the diffuser reflector causes 55% of this otherwise untrapped light to become trapped. Accordingly, the total amount of light propagating in the waveguide 1006 may be increased by up to 25% in accordance with Equation 6 below.

55% ·(100%−55%)=25% (6)

The reflector position and dimensions may be defined to minimize interaction with the light falling within the propagation angle of the waveguide. This interaction may cause that light to be reflected out of the propagation angle of the waveguide.

The configuration described above may enable retention within the waveguide of up to about 80% of the emitted light (i.e., 55% +25%). In practice, however, the retained amount may be less due to, for example, interaction between the diffuser reflector with propagated light, re-absorption of light that strikes the LED surface, and/or absorption on the reflector surfaces. In one embodiment, 75% of the emitted light is retained within the waveguide.

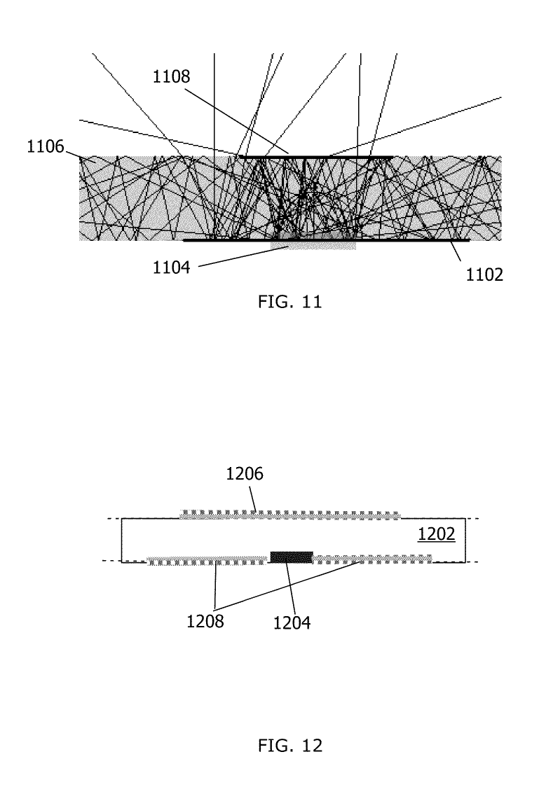

FIG. 11 illustrates how the amount of light propagating within the waveguide may be further increased by the addition of a bottom diffuser reflector 1102 disposed around an embedded LED 1104 in a waveguide 1106 to the top diffuser reflector 1108. This configuration may further increase the amount of light propagating inside the waveguide 1106 by an amount equal to 55% of the light striking the bottom diffuser reflector 1102, as calculated in accordance with Equation 6. The light striking the lower diffuser reflector 1102 is the light not trapped by the upper diffuser reflector 1002, or (0.45−(0.55×(1−0.55)), from Equation 6 above.

55%·(45%−55%·(100%−55%))=11% (7)

Thus, this configuration may enable retention within the waveguide of up to about 91% (i.e., 55%+25%+11%) of the emitted light. In one embodiment, about 85% of light emitted is retained within the waveguide.

The design of the reflector position and size may be optimized according to the dimensions of the LED emitting surfaces and their light-emitting distribution angle. Below is an example of such an optimization performed using conventional ray-tracing optical simulation software.

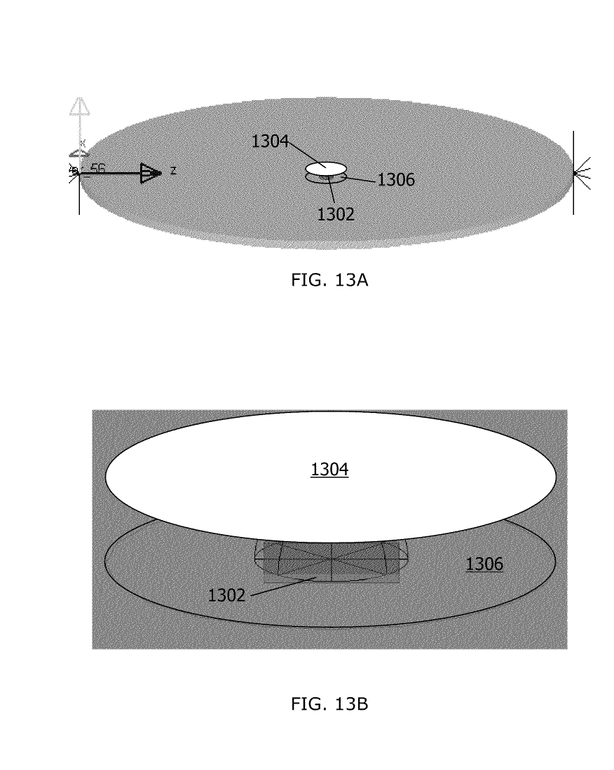

FIG. 12 illustrates the structure of a representative system whose dimensions and configuration are to be optimized. The system includes a waveguide 1202, an embedded LED 1204, an upper reflector 1206, and a lower reflector 1208. FIGS. 13A and 13B illustrate the simulation model used for the optimization. The simulation uses a small LED chip 1302 sized 0.5 mm×0.5 mm and an LED structure with 50% reflectance. The waveguide material is PMMA (having a refractive index of 1.5), and the waveguide thickness is 1 mm. Finally, the simulation uses a Lambertian top diffuser reflector 1304 (having a reflectance Rₜₒₚ of 98%) and a Lambertian bottom diffuser reflector 1306 (having a reflectance R_{bot} of 90%).

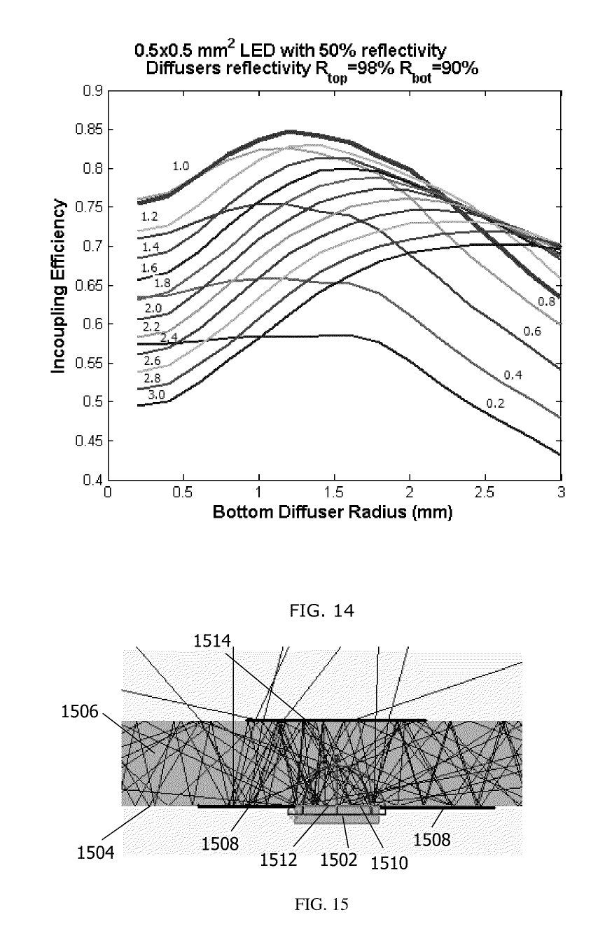

The diameter of the diffuser reflectors is defined to maximize in-coupling efficiency (“IE”), which is the ratio of the amount of light within the propagation angle of the waveguide to the amount of light emitted by the LED. An indication of the amount of light within the propagation angle of the waveguide is the amount of light collected on the surface edge of the waveguide. FIG. 14 shows the optimization results as a series of curves, wherein each curve represents a different top diffuser radius (in mm); the X axis is the bottom diffuser radius and the Y axis is the relative amount of light trapped in the waveguide. A top-only diffuser structure achieves a maximum IE of approximately 75% using a top diffuser with a radius of 0.8 mm. For the top-and-bottom diffuser structure, wherein the bottom diffuser radius is 1.2 mm and the top diffuser radius is 1 mm, maximum IE is approximately 85% as can be seen in the graph in FIG. 14.

FIG. 15 illustrates another embodiment in which an LED 1502 is attached to one surface 1504 of a waveguide 1506 (rather than being embedded within the waveguide) such that the entrance aperture to the waveguide is substantially equal to the size of the emitting area of the LED. The entrance aperture is surrounded by mode-conversion reflectors 1508, such as diffuser reflectors. The waveguide 1506 may include top diffuser reflectors 1514 opposite to the entrance aperture.

Some of the emitted light from the LED may be lost due to Fresnel reflection from the waveguide surface 1504. To mitigate this effect, an index-matching adhesive 1512, with a refractive index similar to that of the waveguide 1506, may be used as an intermediate material between the LED emitting surface 1510 and the waveguide surface 1504. Alternatively or in addition, an anti-reflective coating may be disposed between the LED emitting surface 1510 and the waveguide surface 1504.

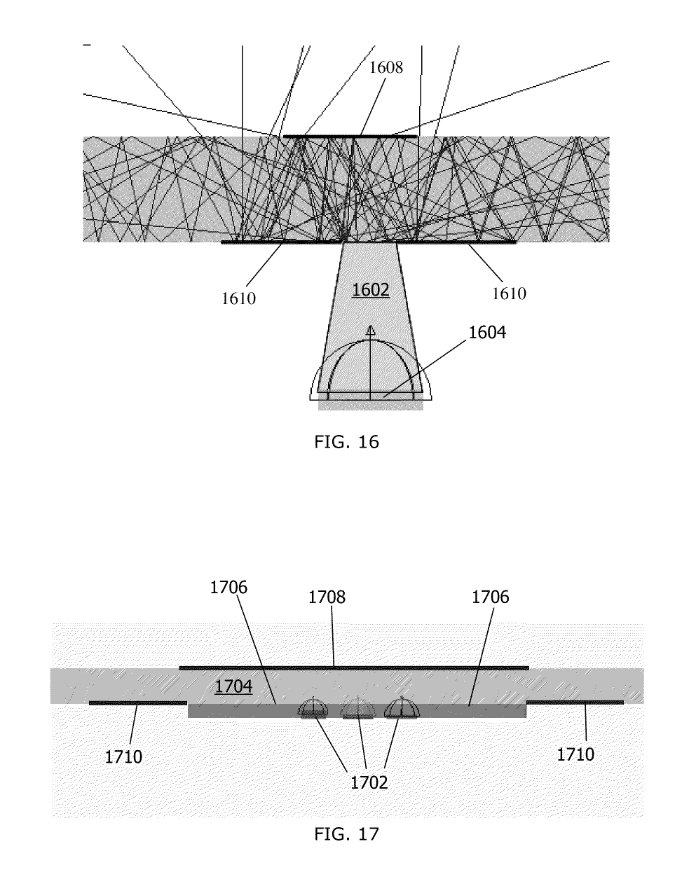

In one embodiment, the area of the entry aperture used to transmit light into the waveguide is reduced by using an optical configuration that focuses the LED light, such as a refractive or diffractive lens or any suitable non-imaging concentration optics. In another embodiment, the area may be reduced by using an LED source that emits light within a concentrated light-distribution angle. FIG. 16 shows an optical configuration 1602 that focuses the light emitted from an attached LED 1604. The optical configuration 1602 may be a lens (e.g., a diffractive lens or a refractive lens), or an optical funnel. The element 1704 may include top and bottom diffuser reflectors 1608, 1610.

In another embodiment, illustrated in FIG. 17, a plurality of LEDs 1702 are embedded inside an element 1704 that acts as an optical funnel and emits the mixed light from the LEDs 1702 from its top surface(s) 1706. The optical funnel 1704 enables the light from the plurality of LEDs to be mixed and transmitted into the waveguide through its bottom surface. The element 1704 may include top and bottom diffuser reflectors 1708, 1710.

In general, integration of an LED and a mode-conversion reflector structure into a waveguide may provide a full illumination device having in-coupling, concentration, propagation, and out-coupling regions as described in, for example, U.S. Ser. No. 12/324,535, filed on Nov. 26, 2008, which is hereby incorporated herein by reference in its entirety. The light propagated inside the waveguide opposite the out-coupling region may be concentrated by the reflecting geometric shape of the waveguide back edge to enforce propagation toward the out-coupling region.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. An illumination structure comprising:
a waveguide;
a discrete light source embedded therein; and
a mode-conversion reflector for converting at least some unconfined modes from the light source into confined modes that propagate fully within the waveguide.

2. The structure of claim 1 wherein the mode-conversion reflector is a diffuser.

3. The structure of claim 1 wherein the discrete light source is a top-emitting LED.

4. The structure of claim 1 wherein the waveguide comprises in-coupling, concentration, propagation, and out-coupling regions.

5. The structure of claim 1 wherein the mode-conversion reflector is disposed on a surface of the waveguide opposite an emission region of the light source.

6. The structure of claim 1 wherein about 75% of light emitted by the light source is retained within the waveguide.

7. The structure of claim 5 further comprising a second mode-conversion reflector surrounding the light source.

8. The structure of claim 7 wherein about 85% of light emitted by the light source is retained within the waveguide.

9. The structure of claim 7 wherein the emission region has an area smaller than an area of the of the first mode-conversion reflector, and the area of the first mode-conversion reflector is smaller than an area of the second mode-conversion reflector.

10. The structure of claim 1 the waveguide has an entrance aperture and the light source has an emitting area, the entrance aperture and the emitting area being approximately equal in size.

11. The structure of claim 10 wherein the entrance aperture is surrounded by mode-conversion reflectors.

12. An illumination structure comprising:
a waveguide having an entrance aperture;
a discrete light source having an emission area substantially conforming to the entrance aperture; and
one or more mode-conversion reflectors surrounding the entrance aperture.

13. The structure of claim 12 wherein (i) the waveguide has a refractive index and (ii) the light source is attached to the waveguide by means of an adhesive having a refractive index substantially matching the refractive index of the waveguide.

14. The structure of claim 12 wherein the emission area of the light source is attached to the entrance aperture of the waveguide through an anti-reflective coating.

15. An illumination structure comprising:
a waveguide having an entrance aperture;
one or more mode-conversion reflectors surrounding the entrance aperture;
a discrete light source; and
an optical element for focusing light from the light source onto the entrance aperture.

16. The structure of claim 15 wherein the optical element is a refractive lens.

17. The structure of claim 15 wherein the optical element is a diffractive lens.

18. The structure of claim 15 wherein the optical element is integral with the light source, the light source emitting light within a narrow light-distribution angle.

19. The structure of claim 15 further comprising a mode-conversion reflector for converting at least some unconfined modes from the light source into confined modes that propagate fully within the waveguide, the mode-conversion reflector being disposed on a surface of the waveguide opposite an emission region of the light source.
